(19) United States
(12) Patent Application Publication
(10) Pub. No.: US 2011/0165373 A1
(43) Pub. Date: Jul. 7, 2011

(54) RADIO-OPAQUE FILMS OF LAMINATE CONSTRUCTION

(75) Inventor: Ashok C. Khandkar, Salt Lake City, UT (US)

(73) Assignee: BIoXR, LLC, Salt Lake City, UT (US)

(21) Appl. No.: 12/897,611

(22) Filed: Oct. 4, 2010

Related U.S. Application Data
(63) Continuation-in-part of application No. 12/683,727, filed on Jan. 7, 2010.

(51) Int. Cl. B32B 9/00; G01N 23/04; B32B 37/02; B32B 3/10; B32B 27/00

(52) U.S. Cl. 428/137; 378/62; 156/60; 428/537.5; 428/457; 428/469; 428/332

(57) ABSTRACT

A radio-opaque film with a laminate structure includes one or more layers of radio-opaque material between a pair of containment layers. Each radio-opaque layer may comprise particles of radio-opaque material and a binder, which holds the particles of radio-opaque material together. One or both of the containment layers may impart the radio-opaque film with paper-like or cloth-like characteristics. Alternatively, a sheet of paper-like or cloth-like material may be adhered to one or both of the containment layers. Methods for manufacturing radio-opaque films are also disclosed, as are systems in which radio-opaque films are used.

### CROSS-REFERENCE TO RELATED APPLICATION

This application is a continuation-in-part of U.S. patent application Ser. No. 12/683,727, filed on Jan. 7, 2010, pending, the disclosure of which is hereby incorporated herein, in its entirety, by this reference.

### TECHNICAL FIELD

The present invention relates generally to radio-opaque films and, more specifically, to radio-opaque films of laminate construction. More specifically, the present invention relates to films in which one or more layers of particulate radio-opaque material are trapped between two containment layers.

### BACKGROUND OF RELATED ART

Modern imaging technologies, such as x-ray, fluoroscopy, and computer tomography (CT), all of which employ ionizing radiation (e.g., x-rays, etc.), have revolutionized diagnostic radiology. The benefits of using imaging technologies are many: living tissues can be non-invasively visualized; radiographic techniques may now be used to diagnose conditions that were once identified with laparoscopic techniques; and diagnosis with radiography is noninvasive, fast and painless. As a result, by one estimate, in 2008 over 178 million x-rays were performed in the United States alone. Over 19,500 CT scans are performed in the United States each day, subjecting each patient to the equivalent of between 30 to about 500 chest radiographs per scan. Annually, about four million CT scans are performed on children. In fact, the United States accounts for half of the most advanced procedures that use ionizing radiation.

Unfortunately, the increase in the use of radiographic procedures comes with a downside: the average American gets the highest per capita dosage of ionizing radiation in the world, with the average dose growing six-fold over the last couple of decades. With the increase in exposure to ionizing radiation comes an increased risk of long term damage (e.g., cancer, genetic damage that may affect future generations, etc.) to the individuals who have been exposed to radiation. The risk of radiation-induced damage is particularly prevalent among health care professionals who are repeatedly exposed to ionizing radiation, either directly or incidentally.

Recognition of the potentially grave effects of repeated exposure to ionizing radiation has lead to the development of radiation-blocking garments. Traditionally, radiation-blocking garments have been manufactured by dispersing lead (Pb) powder throughout polymeric materials, such as rubber and other elastomeric matrices. Since the lead particles are dispersed throughout a polymer matrix, in order to provide a desired level of radiation attenuation, the resulting composite must be relatively thick and cumbersome. It is also heavy, causing discomfort to clinicians who require protection for several hours in a typical day, and are known to lead to problems such as fatigue or back pain.

While the use of thinner lead sheets or foils could provide comparable radiation protection with less weight, they lack the pliability needed for use in garments.

The use of materials than lead, in conjunction with polymeric matrices, to attenuate ionizing radiation has resulted in some weight savings. Nonetheless, lead-free composites are even bulkier than lead-based composites, providing only insignificant weight savings, and typically offer less protection from ionizing radiation than lead-based composites.

### SUMMARY

The present invention includes various embodiments of radio-opaque films. A radio-opaque film of the present invention includes at least one layer of radio-opaque material between a pair of containment layers. The radio-opaque layer may comprise particles of radio-opaque material and a binder, which holds the particles of radio-opaque material together. When held between two pliable containment layers, the radio-opaque layer may also be pliable.

The radio-opaque material may comprise a non-toxic material. The radio-opaque material may comprise an elemental species having an atomic number of 52 or greater. Examples of such elemental species include, but are not limited to, barium, bismuth and lanthanum. In some embodiments, the radio-opaque material may comprise a salt (e.g., barium sulfate, bismuth oxide, etc.).

Some embodiments of radio-opaque films of the present invention include two or more radio-opaque layers. In such embodiments, adjacent layers may include different radio-opaque materials. Layers with different radio-opaque material may be organized to optimize attenuation of ionizing radiation while minimizing the overall thickness of the radio-opaque film.

Methods for manufacturing radio-opaque films are also within the scope of the present invention. In such a method, a radio-opaque material may be deposited onto a surface of a first containment layer, a second containment layer may be disposed over the radio-opaque material, and the first and second containment layers may be secured to one another, capturing the radio-opaque material therebetween. A binder that holds particles of the radio-opaque material together may also adhere to the first and second containment layers and, thus secure the first and second containment layers to one another.

Garments and other apparatus that are made, at least in part, from a radio-opaque film that incorporates teachings of the present invention are also within the scope of the present invention.

Other aspects, as well as features and advantages of various aspects, of the present invention will become apparent to those of ordinary skill in the art through consideration of the ensuing description, the accompanying drawings, and the appended claims.

### BRIEF DESCRIPTION OF THE DRAWINGS

In the drawings:

FIG. 1 is a cross-sectional representation of an embodiment of radio-opaque film of the present invention;

FIG. 2 is a cross-sectional representation of an embodiment of radio-opaque film that includes a plurality of directly adjacent radio-opaque layers between a pair of containment layers;

FIG. 3 is a cross-sectional representation of another embodiment of radio-opaque film, which includes a plurality of physically isolated radio-opaque layers between a pair of containment layers;

FIG. 4 is a cross-sectional representation illustrating a radio-opaque film with a substrate material secured to one of the containment layers;

FIG. 5 schematically depicts use of a radio-opaque film or an apparatus that includes a radio-opaque film;

FIGS. 6 and 7 are graphs that illustrate the attenuation provided by a plurality of radio-opaque film samples and a control swatch at a variety of different intensities of ionizing radiation;

FIGS. 8-10 show x-ray energy spectra at 60 kVp, 90 kVp and 120 kVp, respectively;

FIG. 11 is a graph depicting the degree to which an embodiment of radio-opaque film of the present invention attenuates ionizing radiation relative to various other radio-opaque materials;

FIG. 12 is a graph depicting an example of the weight savings that may be achieved by using a radio-opaque film of the present invention in a frontal radiation shield, relative to the weight of a commercially available lead-free frontal radiation shield; and

The graph of FIG. 13 depicts an example of the weight savings that may be achieved when a radio-opaque film of the present invention is used to manufacture a radiation-blocking garment, as compared with the expected weight of a garment manufactured from a commercially available lead-free material.

### DETAILED DESCRIPTION

The present invention includes radio-opaque films, which may be used in a number of different ways. Without limiting the scope of the present invention, a radio-opaque film of the present invention may be used as a surgical drape, in shields and protective devices that provide an individual with protection from ionizing radiation, in garments that are worn by a healthcare provider (e.g., a doctor, a physician's assistant, a nurse, a technician, etc.) during a procedure (e.g., a surgical procedure, etc.) in which the healthcare provider may be exposed to ionizing radiation, and in radiation shielding curtains. Various embodiments of radio-opaque films that incorporation teachings of the present invention are shown in FIGS. 1 through 4.

In FIG. 1, an embodiment of radio-opaque film 10 is depicted that includes a radio-opaque layer 40 sandwiched between a pair of containment layers 20 and 30. Each containment layer 20, 30 may comprise a thin, flexible film. The material of each containment layer 20, 30 may conform somewhat to the shape of an object, such as the body part of a patient, over which a radio-opaque film 10 that includes the containment layers 20 and 30 is positioned. In some embodiments, the containment layers 20 and 30 may be configured in such a way as to enable folding of the radio-opaque film of which they are a part.

In some embodiments, one or both containment layers 20 and 30 may include at least one surface with features, such as patterned or random texturing, that increase its effective surface area and/or enhance adhesion between that containment layer 20, 30 and the adjacent radio-opaque layer 40.

By way of example, and not by way of limitation, each containment layer 20 and 30 may have a thickness of about 15 mils (0.015 inch, or about 0.375 mm) or less. Of course, embodiments of radio-opaque films 10 that include containment layers 20, 30 of other thicknesses are also within the scope of the present invention.

A variety of different materials are suitable for use as containment layers, including, without limitation, polymers, papers, and fabrics. The material used as each containment layer 20, 30 may be selected on the basis of a number of factors, including, without limitation, the porosity of the material, water-resistance (which may be a function of porosity, the material itself, etc.), bacterial resistance (which may be a function of porosity, incorporation of antibacterial agents into the material, etc.), flexibility, feel, and any other factors. In some embodiments, each containment layer 20, 30 may comprise a polymer or a polymer-based material. More specifically, one or both containment layers 20, 30 may comprise a polymer film or a sheet of woven or non woven polymer fibers with paper-like or fabric-like characteristics. In other embodiments, one or both containment layers 20, 30 may comprise a polymer, but have a structure (e.g., fibers arranged in a way) that resembles paper (e.g., for use as a surgical drape, etc.) or fabric (e.g., for use in a gown, etc.).

In some embodiments, one or both of the containment layers may have some opacity to ionizing radiation, or radio-opacity.

The radio-opaque layer 40 of a radio-opaque film 10 of the present invention includes a material that attenuates ionizing radiation, or a radio-opaque material. In some embodiments, the radio-opaque material of the radio-opaque layer 40 may be in a particulate or powdered form. In such embodiments, the radio-opaque layer 40 may include a binder that holds particles of the radio-opaque material together.

The radio-opaque material may be non-toxic. In various embodiments, the radio-opaque material may comprise or be based upon elemental species having atomic numbers of 56 or greater. Non-limiting examples of such elemental species include barium species, bismuth species and lanthanum species. In some embodiments, the radio-opaque material may comprise an inorganic salt. Non-limiting examples of non-toxic, radio-opaque inorganic salts include barium sulfate and bismuth oxide.

In embodiments where the radio-opaque layer 40 includes a binder, any material that will hold particles of the radio-opaque material together without causing a substantial decrease in the density of the radio-opaque material may be used as the binder. The binder may hold particles of radio-opaque material together loosely, it may provide a stronger bond between adjacent particles, and/or it may enable the formation of a smooth uniform coating, or film. Examples of such materials include, but are not limited to, polyvinyl alcohol (PVA), polyvinyl butyrol (PVB), polyethylene glycol (PEG), glycerine, capric triglyceride, cetyl alcohol, glyceryl sterate and combinations of any of these materials.

In a radio-opaque layer 40 with particles of radio-opaque material held together with a binder, the radio-opaque material may, in some embodiments, comprise at least about 50% of the weight of the radio-opaque layer 40, with the binder comprising about 50% or less of the weight of the radio-opaque layer 40. Other embodiments of radio-opaque layers 40 include about 75% or more of the radio-opaque material, by weight, and about 25% or less of the binder, by weight. In still other embodiments, the radio-opaque material may comprise about 97% or more of the weight of the radio-opaque layer 40, while the binder comprises only up to about 3% of the weight of the radio-opaque layer 40.

In some embodiments, a radio-opaque layer 40 of a radio-opaque film 10 of the present invention has a thickness of about 40 mils (0.040 inch, or 1 mm) or less. In other embodiments, a radio-opaque film 10 may include a radio-opaque layer 40 with a thickness of about 25 mils (0.020 inch, or about 0.6 mm) or less. In still other embodiments, the radio-opaque layer 40 of a radio-opaque film 10 may have a thickness of about 15 mils (0.015 inch, or about 0.375 mm) or less, about 10 mils (0.010 inch, or about 0.25 mm) or less, or about 5 mils (0.005 inch, or about 0.125 mm) or less.

The ability of the radio-opaque layer 40 to attenuate ionizing radiation depends upon a number of factors, including, without limitation, the attenuating ability of each radio-opaque material from which the radio-opaque layer 40 is formed, the relative amounts of radio-opaque material and binder in the radio-opaque layer 40, and the thickness of the radio-opaque layer 40.

The containment layers 20 and 30 may be secured to the radio-opaque layer 40, and to one another, in a number of different ways. As an example, in embodiments where the radio-opaque layer 40 includes a particulate or powdered radio-opaque material and a binder, the binder may adhere or otherwise secure the containment layers 20 and 30 to the radio-opaque layer 40 and, thus, to one another. In other embodiments, the containment layers 20 and 30 may be directly or indirectly secured to one another at a plurality of spaced apart locations (e.g., in a matrix of spaced apart points, a grid of spaced apart row lines and column lines, etc.) with the radio-opaque layer 40 occupying substantially all other areas (i.e., substantially all of the area) between the containment layers 20 and 30. For example, the containment layers 20 and 30 may be directly fused to one another (e.g., by thermal bonding, solvent bonding, etc.). As another example, adhesive material may be disposed between a plurality of spaced apart locations on the containment layers 20 and 30.

Known processes may be used to manufacture a radio-opaque film 10 that embodies teachings of the present invention. In some embodiments, the radio-opaque material and binder may substantially homogeneously mixed in a solvent. The solvent may comprise a carrier solvent within which the binder is provided, or a separately added solvent. In more specific embodiments, the resulting slurry may have a solids content, or solids loading, of about 75% w/w to about 80% w/w. The slurry may then be applied to one of the containment layers 20 in a manner that will result in the formation of a thin film of radio-opaque material over the containment layer 20. In specific embodiments, a doctor blade or simulated doctor blade technique may be employed to form the radio-opaque layer 40. In other embodiments one or more rollers may be employed to form and disperse the radio-opaque layer 40 between the containment layers 20 and 30. The other containment layer 30 may then be applied over the radio-opaque layer 40. In a specific embodiment suitable for mass production, roll calendaring techniques may be used.

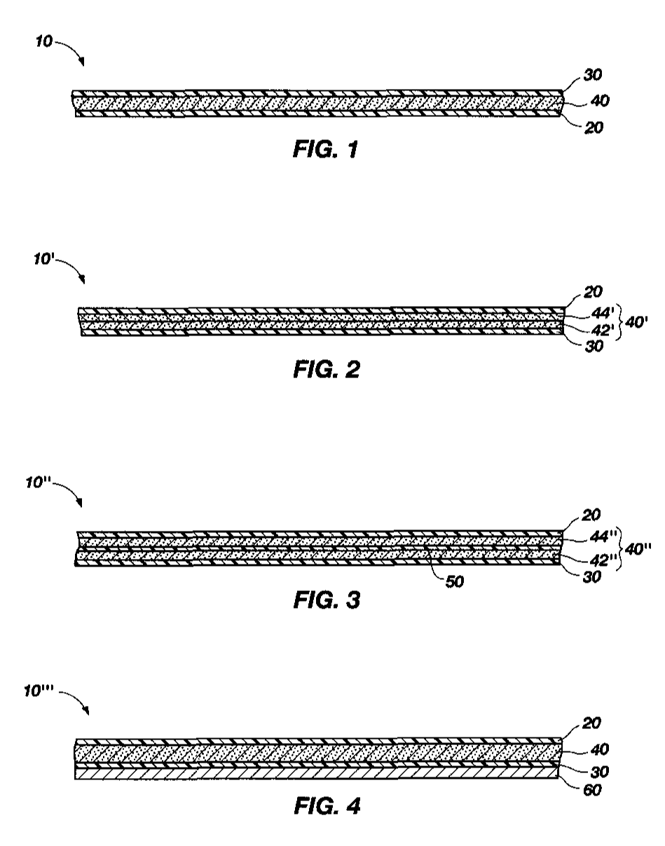

Turning now to FIG. 2, another embodiment of radio-opaque film 10′ of the present invention is shown. Like the radio-opaque film 10 depicted by FIG. 1, radio-opaque film 10′ includes a pair of oppositely facing containment layers 20 and 30 with a radio-opaque layer 40′ between the containment layers 20 and 30. Radio-opaque layer 40′ differs from radio-opaque layer 40, however, in that radio-opaque layer 40′ includes two (as depicted) or more sublayers 42′, 44′, etc. Each sublayer 42′, 44′, etc., includes a different radio-opaque material or mixture of radio-opaque materials than each adjacent sublayer 44′, 42′, etc. In some embodiments, each sublayer (e.g., sublayer 42′) may be based upon an elemental species (e.g., barium, bismuth, lanthanum, etc.) with an atomic number that is less than the atomic number of the elemental species of the radio-opaque material upon which the next successive sublayer (e.g., sublayer 44′) is based. By way of non-limiting example, sublayer 42′ may comprise barium sulfate (barium, or Ba, has an atomic number of 56), while sublayer 44′ may comprise bismuth oxide (bisumuth, or Bi, has an atomic number of 83). Of course, other arrangements of sublayers 42′, 44′, etc., are also within the scope of the present invention.

The use of multiple sublayers 42′, 44′, etc., may provide a radio-opaque layer 40′ an increased attenuation over the use of a single layer of radio-opaque material of the same thickness as radio-opaque layer 40′. When superimposed sublayers 42′, 44′, etc., of different radio-opaque materials are used, selection of the radio-opaque material for each sublayer 42′, 44′ may be based upon the arrangements of their attenuating species (e.g., lattice structures, the distances their attenuating species are spaced apart from one another, etc.), as sublayers 42′ and 44′ with differently arranged attenuating species may attenuate ionizing radiation differently. The material or materials of each sublayer 42′, 44′ may be selected on the basis of their ability to attenuate ionizing radiation over different bandwidths (or ranges) of frequencies or wavelengths, which may impart the radio-opaque layer 40′ with the ability to attenuate a broader bandwidth of frequencies of ionizing radiation than the use of a single layer of radio-opaque material that has the same thickness as radio-opaque layer 40′.

Suitable processes, such as those described in reference to the embodiment of radio-opaque film 10 shown in FIG. 1, may be used to manufacture a radio-opaque film 10′ with two or more adjacent sublayers 42′, 44′, etc. Of course, the use of a plurality of sublayers 42′, 44′, etc., to form the radio-opaque film 40′ requires slight modification of the above-described process, as only the first sublayer 42′ is formed directly on the containment layer 20; each successively formed sublayer 44′, etc., is formed on a previously formed sublayer 42′, etc. Once all of the sublayers 42′, 44′, etc., are formed, the other containment layer 30 may then be positioned over and applied to the uppermost sublayer 44′, etc.

FIG. 3 illustrates another embodiment of radio-opaque film 10″, in which adjacent sublayers 42′, 44′, etc., of the radio-opaque layer 40′ are physically separated from one another by way of an isolation layer 50. Isolation layer 50 may comprise a polymer, such as a low density polyethylene, or any other suitable material. Isolation layer 50 may itself have radio-opaque properties, or it may be substantially transparent to ionizing radiation.

Radio-opaque film 10″ may be manufactured by processes similar to those used to form radio-opaque film 10, with each isolation layer 50 being positioned over and secured to a sublayer 42′, etc. (e.g., by roll calendaring, etc.), then forming each successive sublayer 44′, etc., on an isolation layer 50. After defining the uppermost (or outermost) sublayer 44′, etc., a containment layer 30 is positioned over and secured to that sublayer 44′, etc.

In FIG. 4, an embodiment of radio-opaque film 10′″ that includes an additional substrate 60 secured to one of the containment layers 30 is illustrated. The substrate 60 may comprise any suitable material that may impart the radio-opaque film 10′″ with desirable properties.

For example, in embodiments where the substrate 60 is formed from a paper or a paper-like material (e.g., polyethylene fibers, etc.), it may be readily positioned and repositioned without sticking to a surface (e.g., skin, etc.) over which it is used. A substrate 60 formed from such a material may also impart the radio-opaque film 10′″ with the ability to absorb liquids. Such an embodiment of radio-opaque film 10′″ may be useful as a surgical drape or a similar article to be used in a patient examination room.

In other embodiments, the substrate 60 may be formed from cloth or a cloth-like material (e.g., polyethylene fibers, etc.), which may impart the radio-opaque film 10′″ with a cloth-like appearance, which may be desirable in situations where the radio-opaque film 10′″ is used to form a protective garment, a protective shield (e.g., sheet, etc.), or the like.

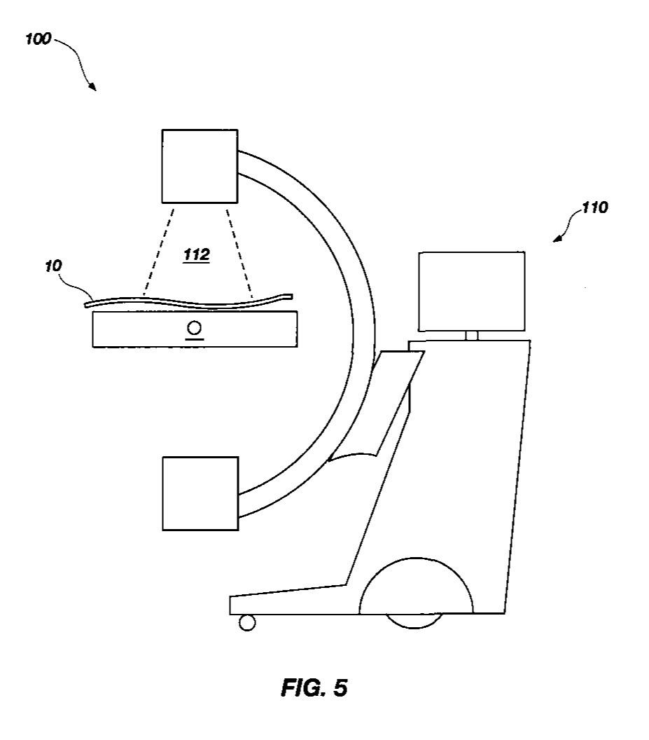

As indicated, a radio-opaque film (e.g., radio-opaque film 10, 10′, 10″, 10′″ or any other embodiment of radio-opaque film) of the present invention may be used to protect a patient, a healthcare provider or both from ionizing radiation. FIG. 5 illustrates an embodiment of the manner in which a radio-opaque film 10 of the present invention, or another article (e.g., a surgical drape, etc.) that includes a radio-opaque film 10, may be used to reduce or eliminate exposure of a patient and/or a healthcare professional to ionizing radiation.

In FIG. 5, an imaging device 110 (e.g., an X-ray machine, a CAT scan (computer aided tomography) machine, a fluoroscope, etc.) is used from a location outside a subject's body O to image an internal portion of the subject's body O. Areas of the subject's body O that are within a radiation field 112 of the imaging device 110 may be covered with a radio-opaque film 10. Additionally, parts of the body of each healthcare professional that may be located within or near the radiation field 112 may be covered with a radio-opaque film 10. Further, parts of the subject's body O that are located inside and or outside of the radiation field 112, as well as parts of the bodies of healthcare professionals that are located inside and or outside of the radiation field 112, but in the same room as the subject, may be shielded from indirect or incidental ionizing radiation by covering those body parts with a radio-opaque film 10.

The EXAMPLE that follows demonstrates the ability of a radio-opaque film 10 that embodies teachings of the present invention to attenuate ionizing radiation.

### Example 1

Several samples of a radio-opaque film were formed by depositing bismuth oxide onto films of polyethylene terephthalate (PET), such as that marketed under the trade name MYLAR® by E.I. du Pont Nemours & Co. of Wilmington, Del. The PET films were cut to lateral dimensions of 5 cm×5 cm. The bismuth oxide was blended with a PVB binder, with the resulting mixture including 80% bismuth oxide, with the balance comprising PEG binder, glycerine, capric triglyceride, cetyl alcohol and glyceryl sterate. That mixture was then suspended in water to form a slurry with a solids content of about 80% w/w.

Two sets of samples were formed using the PET films and the bismuth oxide slurry. In a first set of the samples, the bismuth oxide slurry was applied to the precut PET films at a controlled thickness of 0.010 inch (0.25 mm), then placing another precut PET film over the bismuth oxide slurry and allowing the water to evaporate from the slurry. A second set of samples were prepared in the same manner, but with application of the bismuth oxide slurry at a controlled thickness of 0.015 inch (0.38 mm).

In addition to the bismuth oxide samples, control samples were prepared. Preparation of the control samples included cutting 5 cm×5 cm swatches from an ESP™ radiation shielding examination glove available from Boston Scientific of Natick, Mass. That radiation shielding glove includes lead particles dispersed throughout an elastomer at a solids content of approximately 60%, by weight.

Once sample and control swatch preparation was complete, three tests were performed. In each test, a dosimeter was placed beneath each sample and control swatch, and exposed to ionizing radiation from a Philips C-Arm mobile x-ray device. In a first test, the samples and control swatches were exposed to x-ray radiation at an intensity of 60 kVp for 60 seconds. In a second test, the samples and control swatches were exposed to x-ray radiation at an intensity of 95 kVp for 60 seconds. In a third test, the samples and control swatches were exposed to x-ray radiation at an intensity of 110 kVp for 60 seconds.

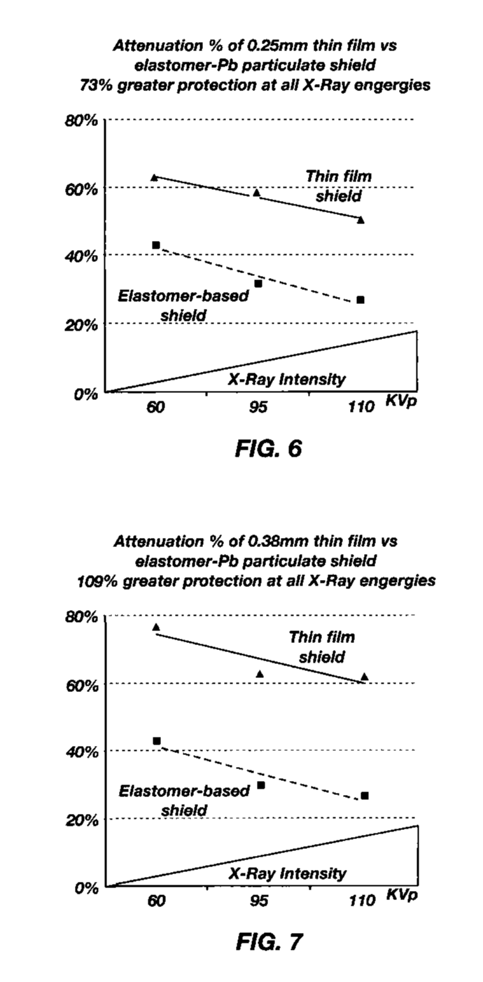

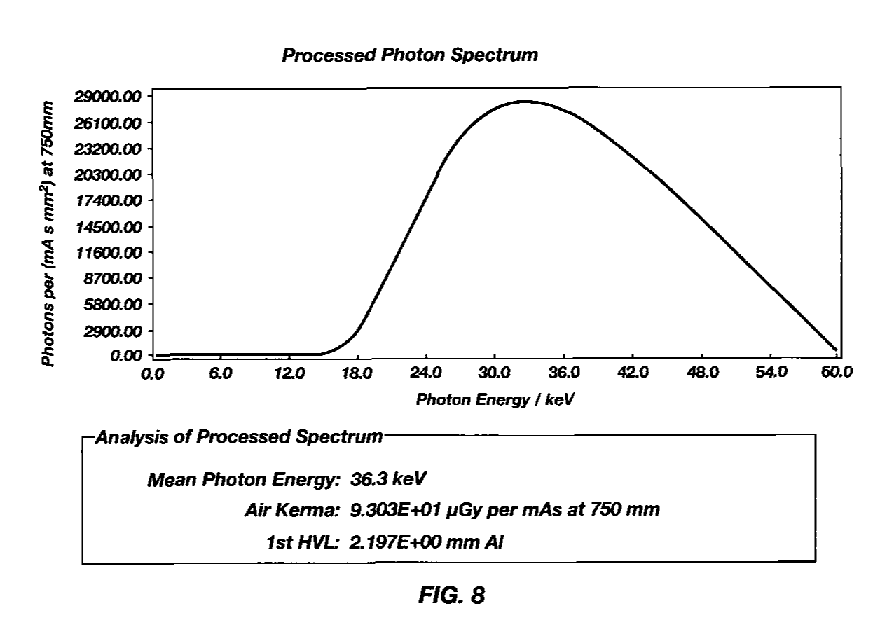

FIGS. 6 and 7 illustrate the attenuation provided by each radio-opaque film sample and control swatch, as determined by the amount of radiation to which the dosimeters were exposed, in terms of the percentage of radiation attenuated at each intensity. FIG. 6 compares the x-ray attenuation ability of a radio-opaque film with a 0.25 mm bismuth oxide layer to the ability of a commercially available elastomer-lead radio-opaque film to attenuate x-rays. FIG. 7 compares the x-ray blocking ability of a radio-opaque film with a 0.38 trim thick bismuth oxide layer to the ability of a commercially available elastomer-lead radio-opaque film to attenuate x-rays.

The data provided by both FIG. 6 and FIG. 7 indicate that the bismuth oxide sample films attenuate significantly more x-ray radiation than the lead-based control swatches. As FIG. 6 demonstrates, the sample with the 0.25 mm thick bismuth oxide film attenuates x-rays at a rate of about 73% more than the commercially available lead-based film. FIG. 7 shows that the 0.38 mm thick bismuth oxide film attenuates nearly twice as much x-ray radiation as the lead-based compound of the control swatch.

### Example 2

In a second study, the ability of a radio-opaque film 10 (FIG. 1) to attenuate x-ray radiation was compared with the attenuation abilities of three other materials, including a lead foil, which served as a reference; a radio-opaque layer from a lead shield, which was rated as having a 0.5 mm lead equivalent attenuation; and a radio-opaque layer from a lead-free shield, which was also rated as having a 0.5 mm lead equivalent attenuation. These products were exposed to the same energies of x-rays for identical amounts of time.

Two radio-opaque films 10 were evaluated: a first having a single radio-opaque layer (a 0.75 mm thick bismuth oxide layer); and a second, which included a 0.7 mm thick bi-layer made of two radio-opaque materials: a 0.35 mm thick bismuth oxide layer (80% w/w bismuth oxide, 20% w/w binder (see EXAMPLE 1); and a 0.35 mm thick bismuth-bismuth oxide layer (80% w/w bismuth-bismuth oxide, including 50% w/w bismuth and 50% w/w bismuth oxide, with the balance comprising the binder (see EXAMPLE 1). Both radio-opaque films included two sheets (about 0.1 mm thick) of TYVEK® flashspun polyethylene fibers with a radio-opaque layer therebetween.

The lead foil used in the study was 99.9% pure foil available from Alfa Aesar. The lead shield, which had a thickness of 1.5 mm, was a 0.5 mm lead-equivalent STARLITE radiation shield (Lot# 10166) available from Bar Ray Products of Littlestown, Pa. The lead-free shield, which had a 0.5 mm lead-equivalent thickness of 1.9 mm, was a TRUE LITE radiation shield (Lot# 10467) available from Bar Ray Products. The lead-free shield, which had a thickness of 1.9 mm, was made from elemental antimony (Sb), in the form of particles embedded in an elastomeric material at a weight ratio of about 1:1.

NANODOT® dosimeters, available from Landauer, Inc., of Glendale, Ill., were used to detect the amount of x-ray radiation that passed through each of the tested products.

Two sets of tests were performed. In a first set of tests, the x-ray attenuating ability of the single layer 0.75 mm specimen was evaluated. In a second set of tests, the ability of the two-layer 0.7 mm specimen to attenuate x-ray radiation was evaluated.

In each set of tests, attenuation was evaluated at x-ray energies of 60 kVp, 90 kVp and 120 kVp. Each of the tests was repeated five times, with previously unused dosimeters used in each individual test.

In the first set of tests, five dosimeters were placed on a surface within an anticipated field of exposure having a diameter of about 250 mm. A Tyvek test specimen and a sample of each of three comparative products (i.e., the lead film, the lead shield and the lead-free shield) were placed over four of the dosimeters. Another dosimeter was not covered. A National Institute of Standards and Technology (NIST)- and ISO-calibrated x-ray source available at Landauer's laboratory was used to simultaneously expose each product to x-ray radiation. One of the predetermined x-ray energies was then generated, with the tested product and the comparative products, as well as the bare dosimeter, within the field of exposure. An ion chamber was used to measure the radiation dosage at the beginning of each of the tests (i.e., different energies). Ion chamber counts were obtained three times to verify reproducibility of the measurements. In each test (i.e., for each energy of x-ray radiation), exposure to the x-ray radiation lasted for 60 seconds.

Following each test, the dosimeters were removed and stored carefully to maintain traceability. Data was then obtained from the dosimeters to determine the measured incident dosages of x-ray radiation (the control provided by the bare dosimeters) and the transmitted dosages of x-ray radiation (the amounts of x-ray radiation attenuated by each product, as measured by the covered dosimeters).

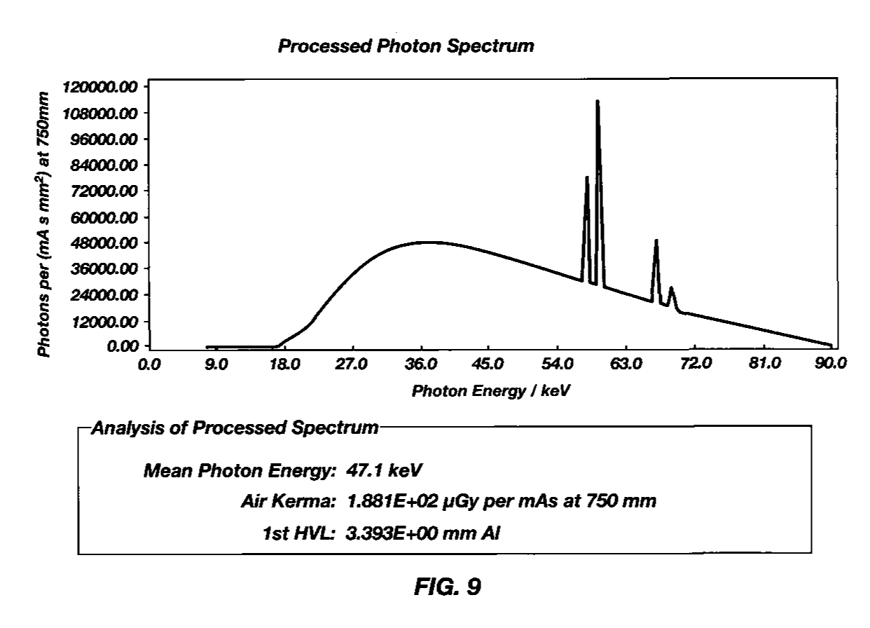

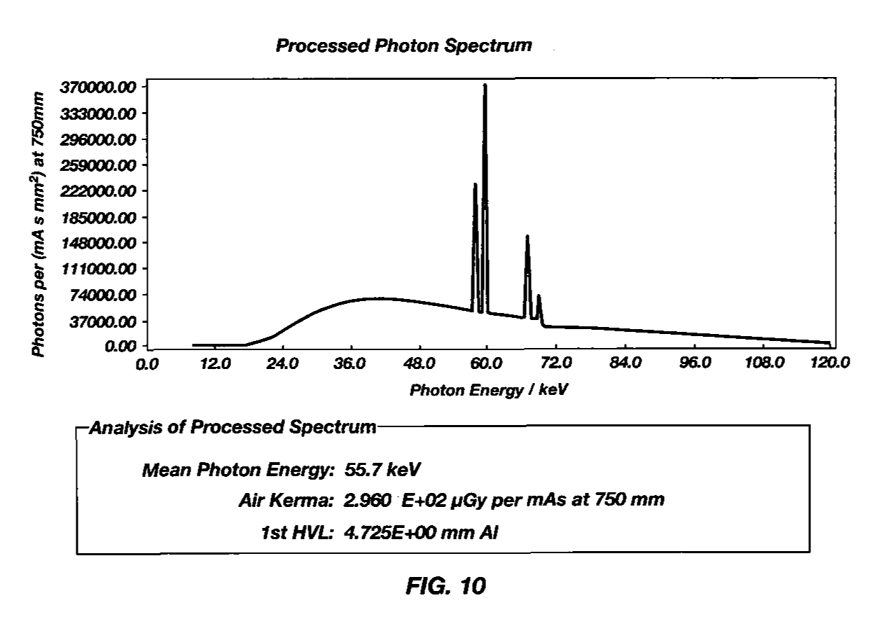

FIGS. 8-10 show the x-ray energy spectra at 60 kVp, 90 kVp and 120 kVp, respectively. In TABLE 1, data corresponding to the dosage of x-ray radiation, measured in mrad, to which each dosimeter (i.e., the bare dosimeter, the dosimeter under the 0.75 mm test product (“Drape”), the dosimeters under the three comparative products “Lead Foil,” “Lead Free,” “Lead Shield”) was exposed is set forth. Each value comprises an average of the five replicate tests at each energy (kVp) of x-ray radiation.

TABLE 1

| | | | | | StdDev of |
|---|---|---|---|---|---|
| | | | | Energy | Energy |
| | | Read Ave | StdDev of | Adjusted Dose | Adjusted |
| KVp | Shielding | mrad | Read mrad | (mrem) | Dose |
| 60 | Bare | 253 | 7 | 243 | 7 |
| | Tyvek Drape | 28 | 2 | 27 | 1 |
| | Lead Foil | 9 | 1 | 8 | 1 |
| | Lead Free | 17 | 1 | 16 | 1 |
| | Lead Shield | 11 | 1 | 10 | 1 |
| 90 | Bare | 533 | 10 | 537 | 10 |
| | Drape | 100 | 4 | 101 | 4 |
| | Lead | 30 | 1 | 30 | 1 |
| | Lead Foil | 19 | 1 | 19 | 1 |
| | Lead Free | 57 | 1 | 58 | 1 |
| 120 | Bare | 850 | 8 | 824 | 8 |
| | Drape | 203 | 5 | 197 | 5 |
| | Lead Foil | 31 | 1 | 30 | 1 |
| | Lead Free | 129 | 3 | 125 | 3 |
| | Lead Shield | 61 | 2 | 59 | 2 |

From these data, the amount of attenuation by each product was calculated using attenuation by the 0.5 mm lead foil (“Lead Foil”) as a baseline. Specifically, the transmitted mrad values for the other products were divided by the transmitted mrad values for the 0.5 mm lead foil. The percent (%) attenuation was then calculated as the complement of the quotient.

The 0.5 mm lead foil attenuates x-ray radiation better than the other products. In decreasing order of x-ray attenuation ability were the 1.5 mm lead shield (98%), the 1.9 mm lead-free shield (92%) and the much thinner 0.75 mm Tyvek test specimen (about 85%). Of course, by increasing the thickness of the radio-opaque layer of the test product, its ability to attenuate x-ray radiation would also increase, approaching that of the lead foil.

In the second set of tests, the ability of two-layer, 0.7 mm test product (“2L BB” in TABLE 2 below) to attenuate three different energies of x-ray radiation was evaluated. In each of the tests, a dosimeter was placed beneath the test product, while another dosimeter was directly exposed to the x-ray radiation. At each energy, five sets of data were obtained. TABLE 2 tabulates the average dosage, in mrad, at each of the three x-ray radiation energies (kVp).

TABLE 2

| | | | | Energy | |
|---|---|---|---|---|---|
| | | Read | Standard | Adjusted | |
| | | Average | Deviation of | Dose | Std Deviation |
| kVp | Shielding | mrad | Delivered mrad | (mrem) | of mrem |
| 60 | 2L BB | 13 | 0.68 | 12 | 0.73 |
| | Bare | 254 | 10.5 | 244 | 10.09 |
| 90 | 2L BB | 49 | 1.95 | 50 | 1.97 |
| | Bare | 542 | 13.91 | 546 | 14.02 |
| 120 | 2L BB | 114 | 5.31 | 111 | 5.15 |
| | Bare | 836 | 14.73 | 811 | 14.29 |

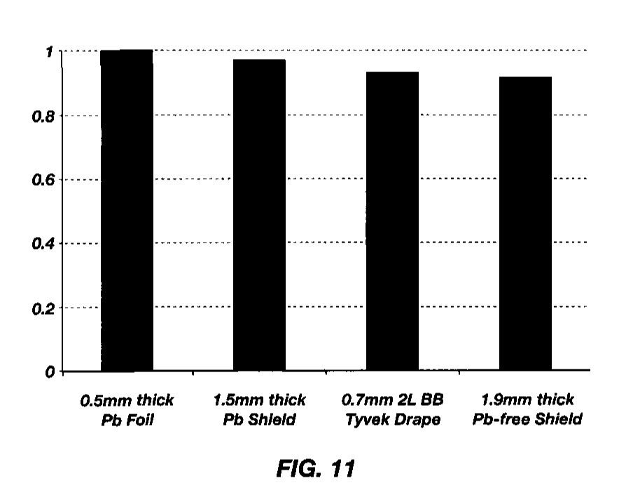

FIG. 11 illustrates the ability of the 0.7 mm radio-opaque layer of the present invention to attenuate ionizing radiation relative to the 0.5 mm thick lead foil, the 1.5 mm thick lead-based radio-opaque layer, and the 1.9 mm thick lead-free radio-opaque layer. Based on the promise provided by the data illustrated by FIG. 11, the estimated weight of a frontal radiation shield (based on the 5,000 cm² area of radio-opaque material used in some commercially available frontal radiation shields) made from a 0.7 mm radio-opaque film of the present invention was calculated, and compared with the known weight of lead frontal radiation shield of the same size.

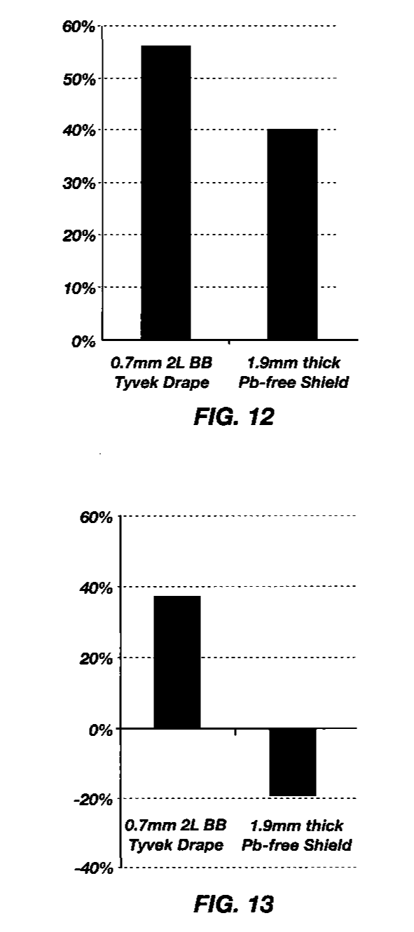

In FIG. 12, the weight savings that would be provided by a frontal radiation shield made from a 0.7 mm radio-opaque film of the present invention is depicted in terms of a percent weight savings, as is the amount of weight savings of a lead-free frontal radiation shield over a lead frontal radiation shield. FIG. 13 shows that a complete gown (about 10,000 cm² total area) made from the 0.7 mm radio-opaque film would still weight significantly less (about 35% less) than the combined weights of a lead frontal radiation shield and sterile gown made from sheets of TYVEK® flashspun polyethylene fibers. In contrast, a gown fashioned from the 1.9 mm lead-free radio-opaque material would weight significantly more (about 20% more) than the combined weights of a lead frontal radiation shield and sterile gown.

From the foregoing, it is apparent that a radio-opaque film that incorporates teachings of the present invention may provide comparable radiation attenuation to existing radio-opaque materials at a significantly reduced thickness and weight.

Although the foregoing description contains many specifics, these should not be construed as limiting the scope of the invention or of any of the appended claims, but merely as providing information pertinent to some specific embodiments that may fall within the scopes of the invention and the appended claims. Other embodiments of the invention may also be devised which lie within the scopes of the invention and the appended claims. Features from different embodiments may be employed in combination. The scope of the invention is, therefore, indicated and limited only by the appended claims and their legal equivalents. All additions, deletions and modifications to the invention, as disclosed herein, that fall within the meaning and scopes of the claims are to be embraced thereby.

What is claimed:

1. A radio-opaque film, comprising:
a first polymer layer;
a second polymer layer; and
a radio-opaque layer between the first and second polymer layers, the radio-opaque layer comprising at least about 50%, by weight of the radio-opaque material.

2. The radio-opaque film of claim 1, further comprising:
a substrate adjacent to the first polymer layer.

3. The radio-opaque film of claim 2, wherein the substrate comprises paper or a paper-like material.

4. The radio-opaque film of claim 1, further comprising a radio-transparent window through at least the radio-opaque layer.

5. The radio-opaque film of claim 1, wherein the radio-transparent window comprises an opening extending through the first polymer layer, the radio-opaque layer, and the second polymer layer.

6. The radio-opaque film of claim 1, wherein the radio-opaque layer further comprises a binder for holding adjacent particles of the radio-opaque material together.

7. The radio-opaque film of claim 6, wherein the binder comprises a polymer.

8. The radio-opaque film of claim 6, wherein the binder comprises at most about 50% of the weight of the radio-opaque layer.

9. The radio-opaque film of claim 1, wherein the radio-opaque material of the radio-opaque film comprises a non-toxic material including molecules with elements having atomic numbers of at least 50 or chemical species of the elements.

10. The radio-opaque film of claim 9, wherein the radio-opaque material comprises an oxidized form or chemical compounds made from such elements.

11. The radio-opaque film of claim 9, wherein a density of the radio-opaque material is less than about 11 grams per cm³.

12. The radio-opaque film of claim 1, wherein the radio-opaque layer includes a plurality of sublayers.

13. The radio-opaque film of claim 12, wherein at least one sublayer of the plurality of sublayers of the radio-opaque layer comprises a different radio-opaque material than an adjacent sublayer of the plurality of sublayers of the radio-opaque layer.

14. The radio-opaque film of claim 13, wherein:
the at least one sublayer is configured to be positioned closer to a source of ionizing radiation than the adjacent sublayer; and
a radio-opaque material of the at least one sublayer is based upon an element having a lower atomic number than an atomic number of another element upon which the different radio-opaque material of the adjacent sublayer is based.

15. The radio-opaque film of claim 12, wherein at least one sublayer of the plurality of sublayers of the radio-opaque layer attenuates ionizing radiation differently than an adjacent sublayer of the plurality of sublayers of the radio-opaque layer.

16. The radio-opaque film of claim 14, wherein the at least one sublayer and the adjacent sublayer comprise different radio-opaque materials.

17. The radio-opaque film of claim 16, wherein the at least one sublayer comprises a first radio-opaque material based on a first element having an atomic number that exceeds an atomic number of a second element upon which a second radio-opaque material of the adjacent sublayer is based.

18. The radio-opaque film of claim 17, configured for placement of the at least one sublayer closer than the adjacent sublayer to a protected surface.

19. The radio-opaque film of claim 18, wherein the at least one sublayer is located closer to the second polymer layer than the adjacent sublayer, and further comprising:
a substrate adjacent to the first polymer layer, the substrate configured to face the source of radiation.

20. The radio-opaque film of claim 12, further comprising:
a barrier between adjacent sublayers of the plurality of sublayers.

21. The radio-opaque film of claim 1, wherein the radio-opaque layer has a thickness of about 20 mils or less.

22. The radio-opaque film of claim 21, wherein the radio-opaque layer has a thickness of about 15 mils or less.

23. The radio-opaque film of claim 22, wherein the radio-opaque layer has a thickness of about 10 mils or less.

24. The radio-opaque film of claim 1, having a thickness of about 50 mils or less.

25. A method for manufacturing a radio-opaque film, comprising:
depositing radio-opaque material onto a surface of a first polymer layer;
disposing a second polymer layer of the radio-opaque material; and
securing the second polymer layer to the first polymer layer to secure the radio-opaque material between the first and second polymer layers.

26. The method of claim 25, further comprising:
depositing another radio-opaque material over the radio-opaque material on the surface of the first polymer layer.

27. The method of claim 26, further comprising:
applying a barrier to the radio-opaque material before depositing the another radio-opaque material.

28. The method of claim 25, wherein depositing the radio-opaque material comprises printing the radio-opaque material onto the surface of the first polymer layer.

29. The method of claim 25, wherein securing comprises adhesively securing the first and second polymer layers to one another.

30. The method of claim 25, wherein securing comprises thermally bonding the first and second polymer layers to one another.

31. The method of claim 30, wherein thermally bonding includes thermally bonding material between the first and second polymer layers to the first and second polymer layers.

32. An imaging system, comprising:
an object to be imaged;
an imaging device configured to direct ionizing radiation in a radiation field over a surface of the object to be imaged; and
a radio-opaque film covering at least a portion of the radiation field to prevent the ionizing radiation from penetrating at least the portion of the surface of the object to be imaged, the radio-opaque film including:
first and second polymer layers; and
a radio-opaque layer between the first and second polymer layers, the radio-opaque layer comprising at least about 50, by weight, radio-opaque material.

33. The imaging system of claim 32, wherein the radio-opaque film further includes:
a radiotransparent window for enabling ionizing radiation to penetrate a desired area of the surface of the object to be imaged.

34. The imaging system of claim 32, wherein the imaging device comprises a device that emits x-rays.
